(19) United States
(12) Patent Application Publication
(10) Pub. No.: US 2008/0203283 A1
(43) Pub. Date: Aug. 28, 2008

(54) OPTICAL ENCODER WITH DETECTOR LENS

(76) Inventors: Yee Loong Chin, Perak (MY); Wee Jin Yeap, Penang (MY); Saiful Bahari Bin Saidan, Selangor (MY)

Correspondence Address: Kathy Manke;Avago Technologies Limited, 4380 Ziegler Road, Fort Collins, CO, 80525, US

(21) Appl. No.: 11/678,154

(22) Filed: Feb. 23, 2007

(51) Int. Cl. G01D 5/34

(52) U.S. Cl. 250/231.13

(57) ABSTRACT

An optical encoder of a transmissive optical encoding system is disclosed. The optical encoder includes an emitter, a detector, and a detector lens. The emitter includes a light source and a collimating lens. The detector includes a plurality of photosensors to detect light from the emitter. The detector lens is aligned with the plurality of photosensors to direct the light toward the plurality of photosensors. Embodiments of the optical encoder provide an increased effective sensing area, increased power delivery to the detector, and increased encoder life.

### BACKGROUND OF THE INVENTION

Optical encoders are used to monitor the motion of, for example, a shaft such as a crank shaft. Optical encoders can monitor the motion of a shaft in terms of position and/or number of revolutions of the shaft. Optical encoders typically use a code wheel attached to the shaft to modulate light as the shaft and the code wheel rotate. In a transmissive code wheel, the light is modulated as it passes through transmissive sections of a track on the code wheel. The transmissive sections are separated by non-transmissive sections. In a reflective code wheel, the light is modulated as it is reflected off of reflective sections of the track on the code wheel. The reflective sections are separated by non-reflective sections. As the light is modulated in response to the rotation of the code wheel, a stream of electrical signals is generated from a photosensor array that receives the modulated light. The electrical signals are used, for example, to determine the position and/or number of revolutions of the shaft.

FIG. 1 illustrates a conventional transmissive optical encoder system 10. The optical encoder system 10 includes an encoder 12 and a transmissive code wheel 14. The encoder 12 includes a light source 16, a collimating lens 20, and a flat package detector 18. Together, the light source 16 and the collimating lens 20 also may be referred to as an emitter. The light source 16 emits light, which is collimated by the collimating lens 20 and is modulated as it passes through the transmissive sections of the code wheel 14. The detector 18 includes a photosensor array such as an array a photodiodes which detects the modulated light. Typically, the photosensor has a resolution that is equal to the resolution of the coding element. It should be noted that conventional transmissive optical encoders do not have a lens at the detector 18.

When an optical encoder is exposed to aerosol contamination such as in a printer environment, some of the aerosol particles deposit on the surface of the collimating lens, the coding element, and the detector module. Similarly, other environmental contaminants such as dirt, dust, paint, and so forth, may deposit on the surfaces of the optical detector, depending on the particular implementations of the optical encoder. These deposited aerosol particles and other contaminants scatter and/or absorb some of the collimated light and, hence, less light will reach the detector. This reduces the power delivery and contrast level of the code scale pattern on the detector chip. Consequently, this causes degradation of the encoder performance.

### SUMMARY OF THE INVENTION

Embodiments of an apparatus are described. In one embodiment, the system is an optical encoder of a transmissive optical encoding system. The optical encoder includes an emitter, a detector, and a detector lens. The emitter includes a light source and a collimating lens. The detector includes a plurality of photosensors to detect light from the light source. The detector lens is aligned with the plurality of photosensors to direct the light toward the plurality of photosensors. Embodiments of the optical encoder provide an increased effective sensing area, increased power delivery to the detector, and increased encoder life.

Another embodiment of the apparatus is also described. In one embodiment, the apparatus includes means for emitting a light signal, means for modulating the light signal, means for detecting the modulated light signal, and means for providing an effective sensing area which is larger than a sensing area of a photosensor array. Other embodiments of the apparatus are also described.

Embodiments of a method are also described. In one embodiment, the method is a method for making an optical encoder for a transmissive optical encoding system. The method includes providing an emitter to generate a light signal, coupling a coding element relative to the emitter, wherein the coding element is configured to modulate the light signal, mounting a detector adjacent to the coding element and opposite from the emitter, wherein the detector is configured to detect the modulated light signal, and mounting a detector lens between the coding element and the detector, wherein the optical lens is configured to provide an effective sensing area which is larger than a sensing area of the detector. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 illustrates a conventional transmissive optical encoder system.

FIG. 2 depicts a schematic circuit diagram of one embodiment of a transmissive optical encoding system.

FIG. 3 depicts a partial schematic diagram of one embodiment of a code wheel.

FIG. 4 depicts a schematic layout of one embodiment of a photosensor array relative to the code wheel track.

FIG. 5 depicts a schematic diagram of one embodiment of a linear code strip.

FIG. 6 depicts a schematic diagram of one embodiment of an optical encoder in which the light source is encapsulated in the collimating lens and the detector is encapsulated in the detector lens.

FIG. 7 depicts a schematic diagram of another embodiment of an optical encoder in which the light source is separated from the collimating lens by an air gap and the detector is separated from the detector lens by another air gap.

FIG. 8A depicts a cross-sectional view of one embodiment of a cylindrical detector lens.

FIG. 8B depicts a perspective view of the cylindrical detector lens of FIG. 8A.

FIG. 8C depicts a schematic layout of one embodiment of a cylindrical detector lens oriented relative to a code wheel track and a photosensor array.

FIG. 9A depicts a cross-sectional view of one embodiment of a cylindrical Fresnel detector lens.

FIG. 9B depicts a perspective view of the cylindrical Fresnel detector lens of FIG. 9A.

FIG. 10A depicts a cross-sectional view of one embodiment of a spherical detector lens.

FIG. 10B depicts a perspective view of the spherical detector lens of FIG. 10A.

FIG. 11A depicts a cross-sectional view of one embodiment of a spherical Fresnel detector lens.

FIG. 11B depicts a perspective view of the spherical Fresnel detector lens of FIG. 11A.

FIG. 12 depicts a schematic flow chart diagram of one embodiment of a method for making an optical encoder for a transmissive optical encoding system.

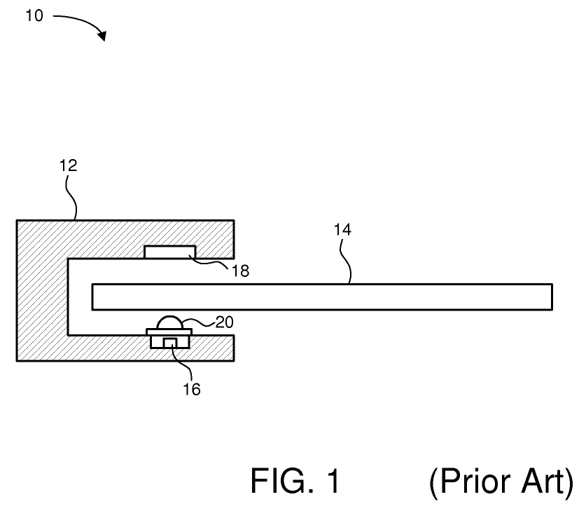

Throughout the description, similar reference numbers may be used to identify similar elements.

### DETAILED DESCRIPTION

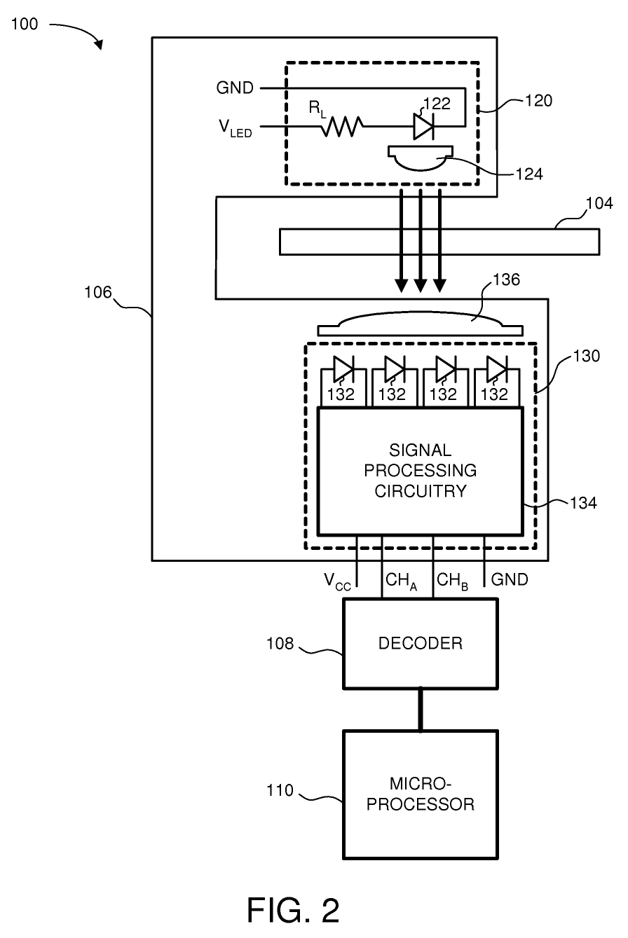

FIG. 2 depicts a schematic circuit diagram of one embodiment of a transmissive optical encoding system 100. The illustrated transmissive optical encoding system 100 includes a code wheel 104, an encoder 106, a decoder 108, and a microprocessor 110. Although a more detailed illustration of the code wheel 104 is provided below with reference to FIG. 3, a brief explanation is provided here as context for the operation of the transmissive optical encoding system 100 shown in FIG. 2.

In general, the code wheel 104 includes a track 140 of transmissive sections 142 and non-transmissive sections 144. An emitter 120 in the encoder 106 produces light (i.e., a light signal) that is incident on the code wheel track 140. As the code wheel 104 is rotated, for example by a motor shaft (not shown), the incident light is transmitted through the code wheel 104 by the transmissive sections 142 of the track 140, but is not transmitted by the non-transmissive sections 144 of the track 140. Thus, the light is transmitted through the track 140 in a modulated pattern (i.e., on-off-on-off . . . ). A detector 130 in the encoder 106 detects the modulated light signal and, in response, generates one or more periodic channel signals (e.g., CH_{A} and CH_{B}). In one embodiment, these channel signals are then transmitted to the decoder 108, which generates a count signal and transmits the count signal to the microprocessor 110. The microprocessor 110 uses the count signal to evaluate the movement of, for example, the motor shaft or other moving part to which the code wheel 104 is coupled. Other embodiments may implement other types of code wheels 104, such as multi-track, absolute position code wheels, as are known in the art.

In one embodiment, the encoder 106 includes the emitter 120 and the detector 130. The emitter 120 includes a light source 122 such as a light-emitting diode (LED). For convenience, the light source 122 is described herein as an LED, although other light sources, or multiple light sources, may be implemented. In one embodiment, the LED 122 is driven by a driver signal, V_{LED}, through a current-limiting resistor, R_{L}. The details of such driver circuits are well-known. Some embodiments of the emitter 120 also may include a collimating lens 124 aligned with the LED 122 to direct the projected light in a particular path or pattern. For example, the collimating lens 124 may direct approximately parallel rays of light onto the code wheel track 140.

In one embodiment, the detector 130 includes one or more photosensors 132 such as photodiodes. The photosensors 132 may be implemented, for example, in an integrated circuit (IC). For convenience, the photosensors 132 are described herein as photodiodes, although other types of photosensors 132 may be implemented. In one embodiment, the photodiodes 132 are uniquely configured to detect a specific pattern or wavelength of transmitted light. In some embodiments, several photodiodes 132 may be used to detect modulated light signals from multiple tracks 140, including positional tracks and index tracks, or a combined position and index track. Also, the photodiodes 132 may be arranged in a pattern that corresponds to the radius and design of the code wheel 104. The various patterns of photodiodes 132 are referred to herein as photosensor arrays.

The electrical signals produced by the photodiodes 132 are processed by signal processing circuitry 134 which generates the channel signals, CH_{A} and CH_{B}. The signal processing circuitry 134 also may generate other signals, including other channel signals, complementary channel signals, or an indexing signal, which may be used to determine the rotational position or the number of rotations of the code wheel 104.

In one embodiment, the detector 130 also includes one or more comparators (not shown) to facilitate generation of the channel signals. For example, analog signals (and their complements) from the photodiodes 132 may be converted by the comparators to transistor-transistor logic (TTL) compatible, digital output signals. In one embodiment, these output channel signals may indicate count and direction information for the modulated light signal.

Additionally, the encoder 106 includes a detector lens 136 to direct the modulated light signal toward the photodiodes 132. In one embodiment, the detector lens 136 is mounted in front of the detector 130 for better light extraction and to ensure sufficient power delivery onto the detector 130. Various embodiments of the detector lens 136 may be implemented, as described below. Some embodiments of the detector lens 136 are beneficial compared to conventional encoders which do not include a detector lens 136. For example, some embodiments of the detector lens 136 increase the power delivery at the detector 130. Also, some embodiments improve the contrast level of the image of the code scale pattern at the detector 130. Additionally, some embodiments extend the life of the encoder 106 in applications involving contamination, such as ink aerosol in printers, because the performance of the encoder 106, having a larger surface area of the detector lens 136, is less affected by contamination particles. In other words, some embodiments enable a larger effective sensing area. This larger effective sensing area increases the power delivery at the detector 130 and, hence, this will lengthen the life of the encoder 106 and improve robustness against contamination such as aerosol contamination.

Additional details of emitters, detectors, and optical encoders, generally, may be referenced in U.S. Pat. Nos. 4,451,731, 4,691,101, and 5,241,172, which are incorporated by reference herein.

FIG. 3 depicts a partial schematic diagram of one embodiment of a code wheel 104. In particular, FIG. 3 illustrates a portion of a circular code wheel 104 in the shape of a disc. In some embodiments, the code wheel 104 may be in the shape of a ring, rather than a disc. The illustrated code wheel 104 includes a track 140, which may be a circular track that is concentric with the code wheel 104. In one embodiment, the track 140 includes a continuous repeating pattern that goes all the way around the code wheel 104. The depicted pattern includes alternating transmissive sections 142 and non-transmissive sections 144, although other patterns may be implemented. In one embodiment, the transmissive sections 142 are transparent sections of the code wheel 104 or, alternatively, voids (e.g., holes) in the code wheel 104. The non-transmissive sections 144 are, for example, opaque sections in the code wheel 104 or, alternatively, reflective sections in the code wheel 104. In one embodiment, the surface areas corresponding to the non-transmissive sections 144 are coated with an absorptive material.

Also, it should be noted that, in some embodiments, the circular code wheel 104 could be replaced with a coding element that is not circular. For example, a linear coding element such as a code strip 170 may be used (see FIG. 5 and the accompanying description). In another embodiment, a circular coding element 104 may be implemented with a spiral bar pattern, as described in U.S. Pat. No. 5,017,776. Alternatively, other light modulation patterns may be implemented on various shapes of coding elements.

As described above, rotation of the code wheel 104 and, hence, the track 140 results in modulation of the transmitted light signal at the detector 130 to measure positional changes of the code wheel 104. Other embodiments of the code wheel 104 may include other tracks such as additional positional tracks or an index track, as are known in the art.

In the depicted embodiment, the transmissive and non-transmissive track sections 142 and 144 have the same circumferential dimensions (also referred to as the width dimension). In other words, the intermediate non-transmissive track sections 144 have the same width dimension as the transmissive track sections 142. The resolution of the code wheel 104 is a function of the width dimensions (as indicated by the span “x”) of the track sections 140 and 142. In one embodiment, the width dimensions of the non-transmissive track sections 144 are a function of the amount of area required to produce a detectable gap between consecutive, transmitted light pulses. The radial, or height, dimensions (as indicated by the span “y”) of the transmissive and non-transmissive track sections 140 and 142 are a function of the amount of area required to generate a sufficient amount of photocurrent (e.g., the more photocurrent that is required, the larger the area required and hence the larger “y” needs to be since area equals “x” times “y”). Typically, the “y” dimension is made substantially larger than the height of the photodiodes 132.

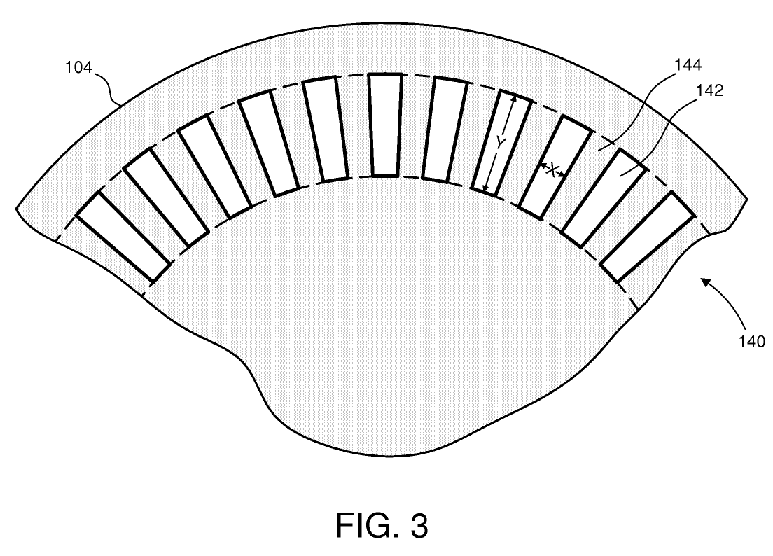

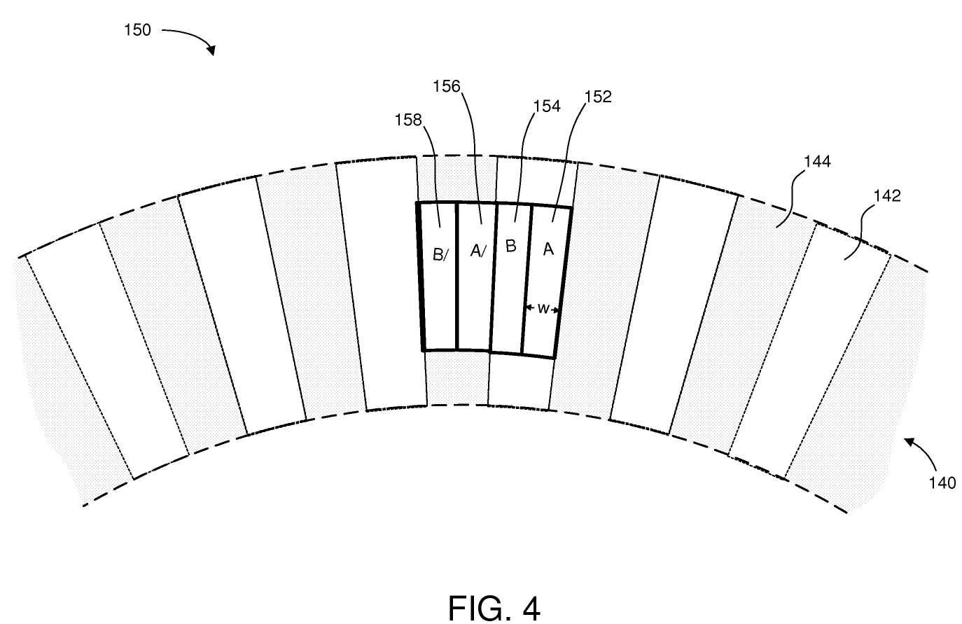

FIG. 4 depicts a schematic layout of one embodiment of a photosensor array 150 relative to the code wheel track 140. The photosensor array 150 is also referred to as a photodiode array. A representation of the code wheel track 140 is overlaid with the photodiode array 150 to depict exemplary dimensions of the individual photodiode array elements (i.e., photodiodes 132) with respect to the sections of the code wheel track 140. Although the photodiode array 150 corresponds to a circular code wheel track 140, other embodiments may implement a photodiode array 150 arranged to align with a linear track 176 of a linear code strip 170.

The illustrated photodiode array 150 includes several individual photodiodes, including an A-signal photodiode 152 to generate an A signal, a B-signal photodiode 154 to generate a B signal, an A/-signal photodiode 156 to generate an A/signal, and a B/-signal photodiode 158 to generate a B/signal. For clarification, “A/” is read as “A bar” and “B/” is read as “B bar.” This designation of the position photodiodes 152, 154, 156, and 158 and the corresponding electrical signals that are generated by the position photodiodes 152, 154, 156, and 158 is well-known in the art. The circumferential dimensions (also referred to as the width dimensions, indicated by the span “w”) of the position photodiodes 152, 154, 156, and 158 are related to the width dimensions of the position track sections 142 and 144 of the corresponding code wheel track 140. In the embodiment of FIG. 4, each position photodiode 152, 154, 156, and 158 has a width that is one half the width of the transmissive and non-transmissive track sections 142 and 144 of the corresponding position track 140 (i.e., “w” equals “x/2”). Other embodiments of the photosensor array 150 may include other photosensors 132, as are known in the art.

FIG. 5 depicts a schematic diagram of one embodiment of a linear code strip 170. The functionality of the code strip 170 is substantially similar to the functionality of the code wheel 104 described above, except that the code strip 170 may be used to monitor movement in a substantially linear direction. The code strip 170 includes transmissive sections 172 and non-transmissive sections 174, which are position sections. In one embodiment, each of the position track sections 172 and 174 has approximately the same width dimension (indicated by the “X”). Similarly, the position track sections 172 and 174 have approximately the same height dimension (indicated by the “Y”). Other embodiments of the linear code strip 170 may include other track sections, as are known in the art.

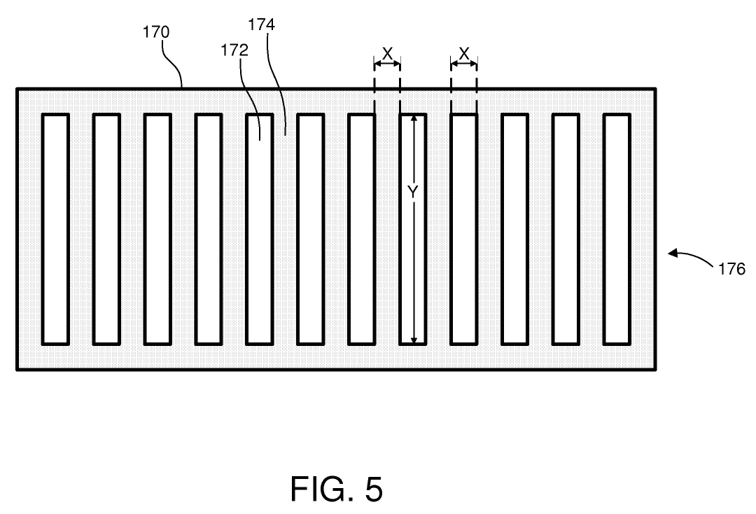

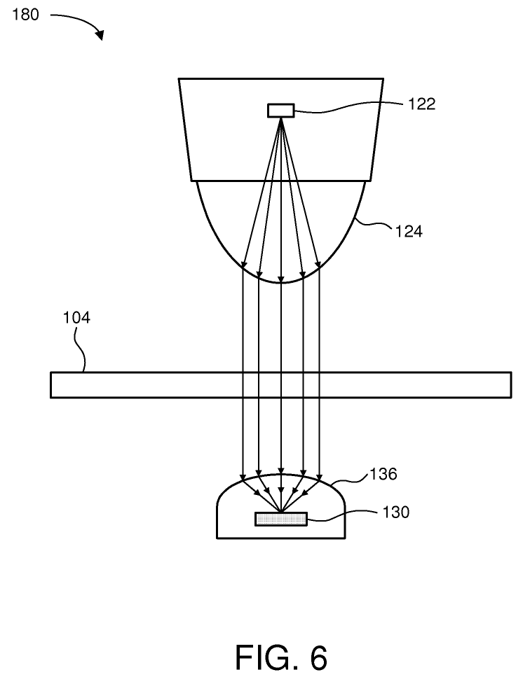

FIG. 6 depicts a schematic diagram of one embodiment of an optical encoder 180 in which the light source 122 is encapsulated in the collimating lens 124, and the detector 130 is encapsulated in the detector lens 136. One example of an encapsulant which may be used to form the lenses 124 and 136 is an epoxy, although other types of encapsulants may be used. In some embodiments, the collimating lens 124 and the detector lens 136 may be made of the same material, although different encapsulating materials may be used. In the illustrated embodiment, the light source 122 generates a light signal which propagates through the encapsulant of the collimating lens 124 and refracts into a collimated beam of light. The collimated beam of light is incident on the code wheel 104 and passes through one or more transmissive sections 142 of the code wheel track 140 as the code wheel 104 rotates. The light that passes through the transmissive sections 142 is then incident on the detector lens 136, which directs the light toward the photosensor array 150 of the detector 130. As mentioned above, encapsulating the detector 130 in this manner effectively increases the sensing area of the detector and helps to minimize the negative effects of surface contaminants.

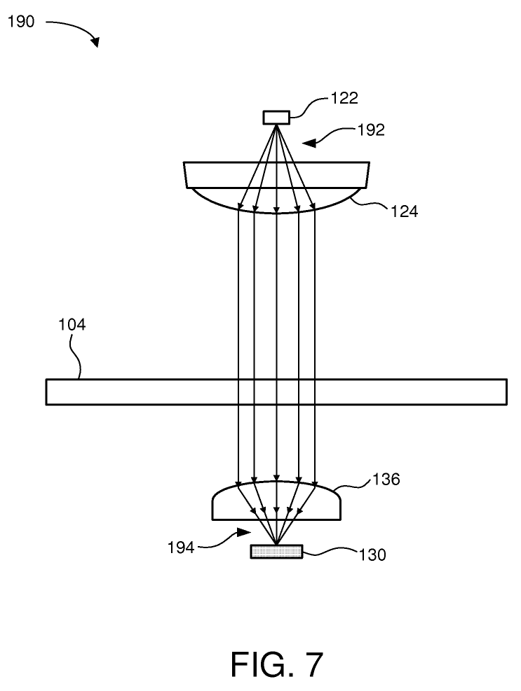

FIG. 7 depicts a schematic diagram of another embodiment of an optical encoder 190 in which the light source 122 is separated from the collimating lens 124 by an air gap 192, and the detector 130 is separated from the detector lens 136 by another air gap 194. Although this illustrated embodiment has air gaps 192 and 194 at both the emitter 120 and the detector 130, other embodiments may have a single air gap at either the emitter 120 or the detector 130. In other words, some embodiments have an air gap 192 between the light source 122 and the collimating lens 124, while the detector 130 is encapsulated by the detector lens 136. Alternatively, some embodiments have an air gap 194 between the detector 130 and the detector lens 136, while the light source 122 (or the entire emitter 120) is encapsulated by the collimating lens 124.

It should be noted that, where the optical encoder 190 includes an air gap 192 between the light source 122 and the collimating lens 124, the housing (not shown) or other mounting structures of the optical encoder 190 may accommodate the light source 122 and the collimating lens 124 so that the light source 122 is effectively shielded from contaminants. For example, the light source 122 may be mounted in a recess which is subsequently covered by the collimating lens 124. Alternatively, the collimating lens 124 may be designed and mounted over the light source 122 with a cavity to accommodate the light source 122. In another embodiment, the collimating lens 124 may be mounted directly on top of the light source 122.

Similarly, where the optical encoder 190 includes an air gap 194 between the detector 130 and the detector lens 136, the detector lens 136 may be mounted on top of a recess of the housing (not shown) which accommodates the detector 130. Alternatively, the detector lens 136 may have a recess on the back side of the detector lens 136 to accommodate the detector 130. In another embodiment, the detector lens 136 may be mounted directly on top of a flat package detector 130.

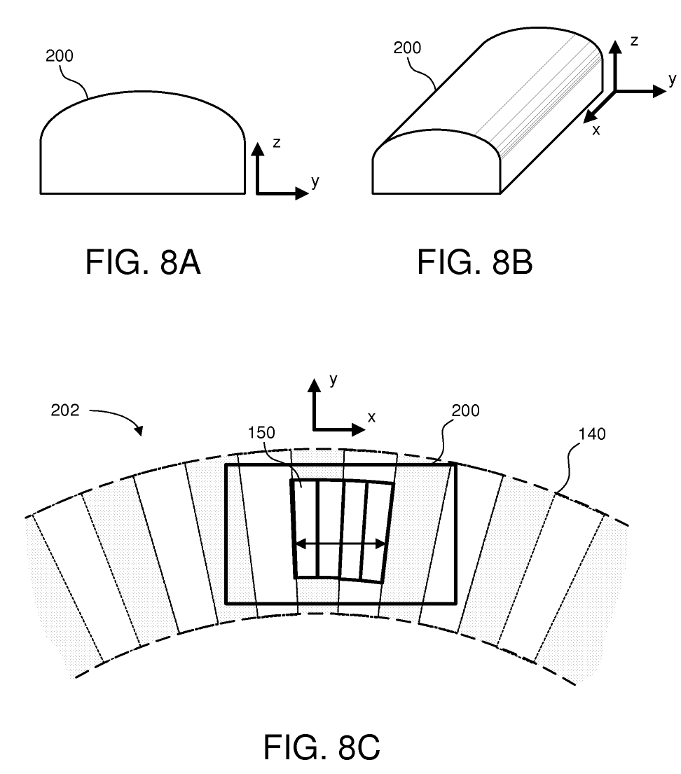

FIG. 8A depicts a cross-sectional view of one embodiment of a cylindrical detector lens 200. FIG. 8B depicts a perspective view of the cylindrical detector lens 200 of FIG. 8A. In one embodiment, the cylindrical detector lens 200 is substantially larger than the surface area of the photosensor array 150 for which it is designed.

FIG. 8C depicts a schematic layout of one embodiment of a cylindrical detector lens 200 oriented relative to a code wheel track 140 and a photosensor array 150. In one embodiment, the cylindrical detector lens 200 is orientated relative to the other components of the optical encoder 106 in such a manner that the cross-section plane (see FIG. 8A) containing the cylindrical lens surface profile is perpendicular to the scanning direction of the encoder 106, as indicated by the arrow superimposed on the photosensor array 150. In other words, the cylindrical detector lens 200 is oriented with a cylindrical cross-section approximately perpendicular to a scanning direction of movement of a coding element 104 so that the cylindrical detector lens 200 maintains the native resolution of the detector 130. While there is a magnification factor in the direction of the height of the photosensor array 150, there is not a magnification factor in the direction of the width of the photosensor array 150.

By introducing a magnification factor in the direction of the height of the photosensor array 150, the cylindrical detector lens 200 enlarges the effective sensing area in the direction containing the lens surface profile. However, this magnification factor does not affect the collimation beam quality in the direction of encoder scanning, as shown by the arrow. Hence, there is no magnification factor in the direction of the width of the photosensor array 150 between code scale resolution and the photosensor resolution of detector 130.

Additionally, the larger effective sensing area provided by the cylindrical detector lens 200 increases the power delivery onto the detector 130 and, hence, lengthens the life of the encoder 106. The encoder 106 will also be more robust towards contaminants such as ink aerosol.

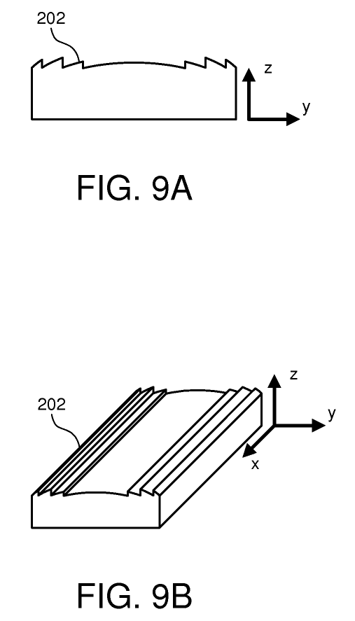

FIG. 9A depicts a cross-sectional view of one embodiment of a cylindrical Fresnel detector lens 202. FIG. 9B depicts a perspective view of the cylindrical Fresnel detector lens 202 of FIG. 9A. The depicted cylindrical Fresnel detector lens 202 functions substantially similarly to the cylindrical detector lens 200 described above. However, embodiments of the cylindrical Fresnel detector lens 202 may have a lower profile than the cylindrical detector lens 200 of FIG. 8A. This lower profile may decrease production costs or may allow embodiments of the encoder 106 to be thinner than embodiments which use a non-Fresnel cylindrical detector lens. Although a particular lens pattern is shown for the cylindrical Fresnel detector lens 202, other embodiments may implement other lens patterns with more or less Fresnel zones. Additionally, other embodiments may include non-cylindrical elements to enhance the directivity or magnification of the cylindrical Fresnel detector lens 202 in one or more directions.

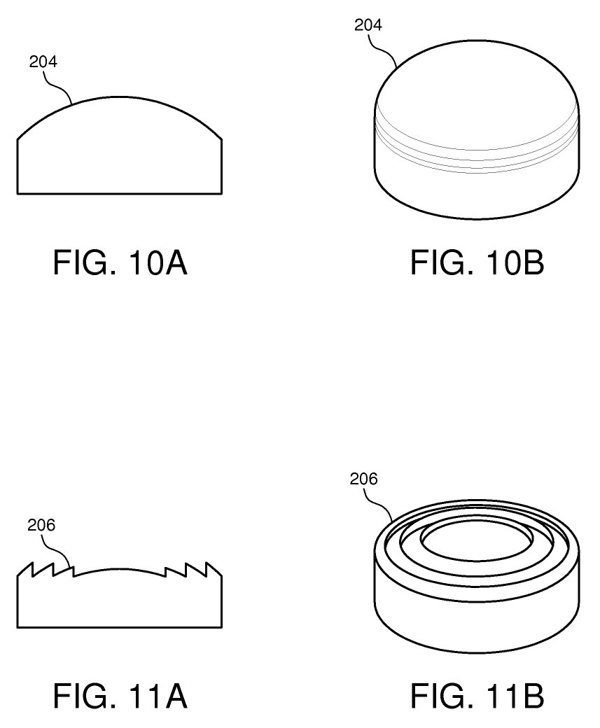

FIG. 10A depicts a cross-sectional view of one embodiment of a spherical detector lens 204. FIG. 10B depicts a perspective view of the spherical detector lens 204 of FIG. 10A. While some embodiments of the spherical detector lens 204 provide similar functionality as, for example, the cylindrical detector lens 200, there are also some differences between the spherical detector lens 204 and the cylindrical detector lens 200. Given the omni-directional shape of the spherical detector lens 204, a magnification factor is associated with all orientations the spherical detector lens 204, rather than in a single direction. Hence, the spherical detector lens 204 features demagnification of the code scale image onto the photosensor array 150 of the detector chip 130, including in the direction of scanning movement. Thus, a smaller integrated circuit (IC) size may be used, which allows lower cost and smaller encoder package design.

Additionally, some embodiments of the spherical detector lens 204 may include a spherical or at least partially aspheric surface profile. Like the cylindrical detector lens 200, the spherical detector lens 204 also enables a larger effective sensing area, which increases the power delivery at the detector 130. This lengthens the life of the encoder 106, and the encoder 106 will be more robust towards aerosol and other contamination.

FIG. 11A depicts a cross-sectional view of one embodiment of a spherical Fresnel detector lens 206. FIG. 11B depicts a perspective view of the spherical Fresnel detector lens 206 of FIG. 11A. The depicted spherical Fresnel detector lens 206 functions substantially similarly to the spherical detector lens 204 described above. However, embodiments of the spherical Fresnel detector lens 206 may have a lower profile than the spherical detector lens 204 of FIG. 10A. This lower profile may decrease production costs or may allow embodiments of the encoder 106 to be thinner than embodiments which use a non-Fresnel spherical detector lens. Although a particular lens pattern is shown for the spherical Fresnel detector lens 206, other embodiments may implement other lens patterns with more or less Fresnel zones. Additionally, other embodiments may include aspheric elements to enhance the directivity or magnification of the spherical Fresnel detector lens 206 in one or more directions.

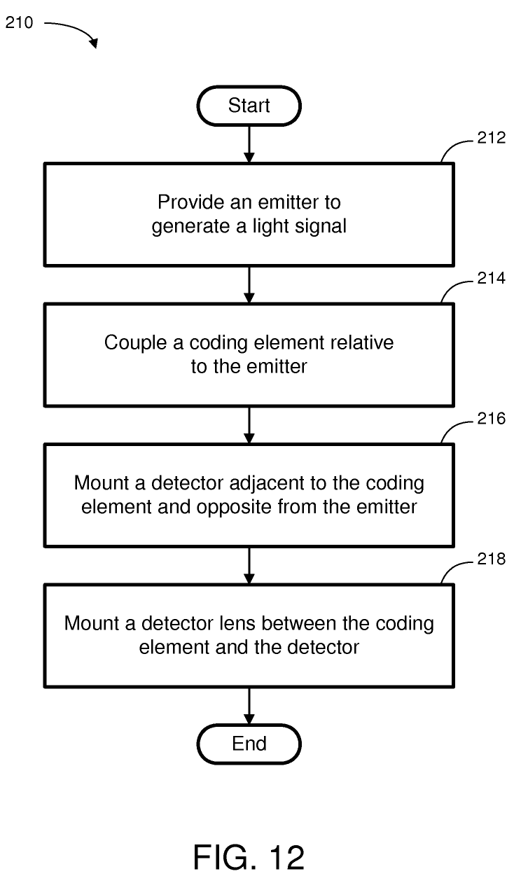

FIG. 12 depicts a schematic flow chart diagram of one embodiment of a method 210 for making an optical encoder 106 for a transmissive optical encoding system 100. Although specific reference is made to the optical encoder system 100 of FIG. 2, some embodiments of the method 210 may be implemented in conjunction with other optical encoder systems, as described above.

At block 212, an emitter 120 is provided. The emitter 120 is configured to generate a light signal. One example of an emitter 120 is a LED coupled to a collimating lens 124, although other types of light sources 122 may be implemented. At block 214, a coding element such as a code wheel 104 or a code strip 170 is coupled to the emitter 120. Although the coding element is coupled to the emitter 120, such coupling may be indirect in that the emitter 120 and the coding element are not in direct physical contact. It is sufficient that the coding element be in a position relative to the emitter 120 so that the light signal from the emitter 120 is incident on at least a portion of the coding element.

At block 216, a detector 130 is mounted adjacent to the coding element and opposite from the emitter 120. In other words, the detector 130 is mounted on one side of the coding element, and the emitter 120 is mounted on the other side of the coding element. This configuration facilitates the use of a transmissive coding element such as a transmissive code wheel 104. At block 218, a detector lens 136 is mounted between the coding element and the detector 130. The detector lens 136 can have different shapes depending on the configuration of the optical encoding system 100. For example, some embodiments use a cylindrical detector lens 200. Other embodiments of the optical encoding system 100 use a spherical detector lens 204. Alternatively, other embodiments may use a Fresnel lens, an aspheric lens, or another type of detector lens 136, as described above. It should be noted that the operations of blocks 216 and 218 may be implemented concurrently, for example, where a detector lens 136 encapsulates the detector 130 so that they are both mounted in the optical encoder system 100 at the same time. The depicted method 210 then ends.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

1. An optical encoder of a transmissive optical encoding system, the optical encoder comprising:
an emitter comprising a light source and a collimating lens;
a detector comprising a plurality of photosensors to detect light from the light source of the emitter; and
a detector lens aligned with the plurality of photosensors of the detector, wherein the detector lens is configured to direct the light toward the plurality of photosensors, wherein the detector lens encapsulates the detector.

2. The optical encoder of claim 1 further comprising a coding element disposed between the emitter and the detector, wherein the coding element is configured to modulate the light according to a movement of the coding element relative to the emitter.

3. The optical encoder of claim 1 wherein the emitter further comprises an air gap between the light source and the collimating lens.

4. (canceled)

5. (canceled)

6. The optical encoder of claim 1 wherein the detector lens comprises a cylindrical detector lens, wherein the cylindrical detector lens is oriented with a cylindrical cross-section approximately perpendicular to a scanning direction of movement of a coding element so that the cylindrical detector lens maintains the resolution of the detector.

7. The optical encoder of claim 1 wherein the detector lens comprises a spherical detector lens.

8. The optical encoder of claim 1 wherein the detector lens comprises a Fresnel lens.

9. The optical encoder of claim 1 wherein the detector lens comprises an aspheric detector lens.

10. The optical encoder of claim 1 wherein the plurality of photosensors of the detector are arranged in a photosensor array characterized by an array resolution which is different from a code scale resolution of a coding element, wherein the array resolution and the code scale resolution are related by a magnification factor of the detector lens.

11. The optical encoder of claim 1 wherein the detector lens is mounted relative to the detector to prevent a contaminant from depositing on the detector.

12. An optical encoder of a transmissive optical encoding system, the optical encoder comprising:
means for emitting a light signal;
means for modulating the light signal;
means for detecting the modulated light signal;
means for preventing a contaminant from depositing on the photosensor array; and
means for providing an effective sensing area which is larger than a sensing area of a photosensor array.

13. The optical encoder of claim 12 further comprising means for increasing power delivery of the modulated light signal to the photosensor array.

14. The optical encoder of claim 12 further comprising means for collimating the light signal.

15. The optical encoder of claim 12 further comprising means for improving a contrast level of an image of the modulated light signal at the photosensor array.

16. (canceled)

17. The optical encoder of claim 12 further comprising means for compensating for a magnification difference between an array resolution of the photosensor array and a code scale resolution of a coding element in a scanning direction of movement of the coding element.

18. A method for making an optical encoder for a transmissive optical encoding system, the method comprising:
providing an emitter to generate a light signal;
coupling a coding element relative to the emitter, wherein the coding element is configured to modulate the light signal;
mounting a detector adjacent to the coding element and opposite from the emitter, wherein the detector is configured to detect the modulated light signal; and
mounting a detector lens between the coding element and the detector, wherein the detector lens is configured to provide an effective sensing area which is larger than a sensing area of the detector, wherein the detector lens encapsulates the detector.

19. The method of claim 18 wherein the detector lens is a cylindrical, spherical, or aspheric detector lens.

20. (canceled)
